(19) United States
(12) Patent Application Publication
(10) Pub. No.: US 2013/0090003 A1
(43) Pub. Date: Apr. 11, 2013

(54) PLUG CONNECTION HAVING INCREASED VIBRATION RESISTANCE

(71) Applicants: Gerald Friess, Grossbottwar (DE); Wolfgang Mueller-Hirsch, Esslingen (DE); Markus Kroeckel, Schwieberdingen (DE)

(72) Inventors: Gerald Friess, Grossbottwar (DE); Wolfgang Mueller-Hirsch, Esslingen (DE); Markus Kroeckel, Schwieberdingen (DE)

(21) Appl. No.: 13/516,384

(22) PCT Filed: Nov. 4, 2010
(86) PCT No.: PCT/EP10/66828

§ 371 Date: Dec. 19, 2012

(30) Foreign Application Priority Data
Dec. 18, 2009 (DE) 102009055014.3

(51) Int. Cl. H01R 13/62

(52) U.S. Cl. CPC H01R 13/62
USPC 439/384

(57) ABSTRACT

A plug connection between at least one cable connector and a terminal housing includes an electrical plug connection having at least one socket on the terminal housing for inserting the cable connector, a non-electrical plug connection being provided between the at least one cable connector and the terminal housing in addition to the electrical plug connection.

### BACKGROUND OF THE INVENTION

1. Field of the Invention

The present invention relates to a plug connection having increased vibration resistance.

2. Description of the Related Art

Multi-pin plug connections are used for electronic control units (e.g. Motronic, electronic diesel control (EDC)). Vibration stresses at the installation location may result in typical wear patterns of wearing through or frictional corrosion at the contacts due to relative movements in the plug connection, e.g. between a cable harness connector and a control unit housing. For design reasons, the mass concentrated in the plug connection and cable harness results in a relative movement of the cable harness side relative to the male multipoint connector. In addition to the internal design of the plug connection, additional measures, such as a short cable harness holder in the vicinity of the control unit or a screw connection of the male multipoint connector in the control unit housing, result in a reduction in this relative movement and thus in an increase in the vibration resistance. However, such a screw connection of the male multipoint connector is not desired or possible for every type of housing.

### BRIEF SUMMARY OF THE INVENTION

According to the present invention, the entire plug connection outside of the actual electrical plug connection is directly connected via at least one additional non-electrical plug connection to the terminal housing, the mass of the entire plug connection consequently being able to be supported on the terminal housing or an adapter secured thereto so that relative movements of the entire plug connection are significantly reduced in all three spatial axes. Moreover, the connection length and thus the mass of the cable section introducing the relative movements are able to be reduced and also secured on the same vibration level as the control unit. It is advantageous for tampering protection to secure the additional non-electrical plug connection via hidden retaining hooks so that this additional plug connection and thus the entire plug connection are not able to be disconnected without being destroyed.

The non-electrical plug connection is preferably made of at least one connection pin of the terminal housing projecting opposite to the connection direction of the cable connector and by at least one corresponding connection receptacle of the cable connector, or vice versa. The connection receptacle(s) of every cable connector is/are pushed onto the connection pin(s), which is/are preferably a permanent component of the terminal housing or the adapter and may be die-cast aluminum parts or molded sheet-metal parts. The associated connection receptacles of the cable connector are preferably a permanent part of the connector housing and may be made of, for example, a plastic frame molded to the connector housing. If the connection pins protrude beyond the collar of the male multipoint connector, the risk of internal damage to the male multipoint connector or its seal in the case of unintentional falling of the terminal housing may be prevented and internal damage may be deduced from damaged connection pins.

One or more damping elements of elastic material are advantageously situated in the at least one connection receptacle of the non-electrical plug connection to thus further dampen the non-electrical plug connection.

Moreover, the terminal housing preferably has at least one contact surface for securing the cable of an inserted cable connector. This cable securing means is integrated directly into the terminal housing or adapter to ensure a phase-equivalent vibration level with respect to the terminal housing and represents a second securing point in addition to the non-electrical plug connection resulting in further damping of the rotation movements of the cable under vibration stress. It is particularly preferable for the at least one contact surface to have at least two cable securing means at a distance from one another in the longitudinal direction of the cable of the inserted cable connector, in particular openings for cable ties, in order to secure the supported cable to the contact surface at two locations at a distance from one another and thus to prevent rotation or torsion of the supported cable.

### BRIEF DESCRIPTION OF THE DRAWINGS

FIGS. 1a through 1e show a perspective view of a first specific embodiment of the plug connection according to the present invention having a terminal housing and two cable connectors from above (FIG. 1a) and from below (FIG. 1b), in detail (FIG. 1c), the terminal housing and one of the cable connectors being shown separately in FIGS. 1d and 1e, respectively.

FIG. 2 shows a second specific embodiment of the plug connection according to the present invention having a modified cable connector, the terminal housing being omitted.

FIGS. 3a and 3b show two modified terminal housings of the electrical plug connection according to the present invention.

### DETAILED DESCRIPTION OF THE INVENTION

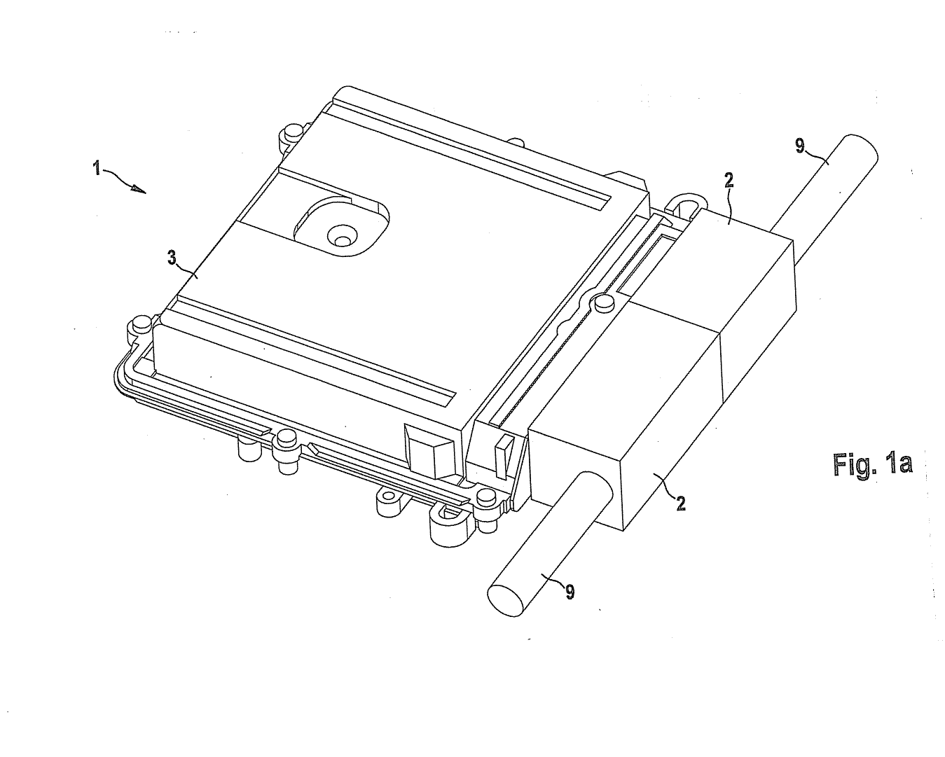

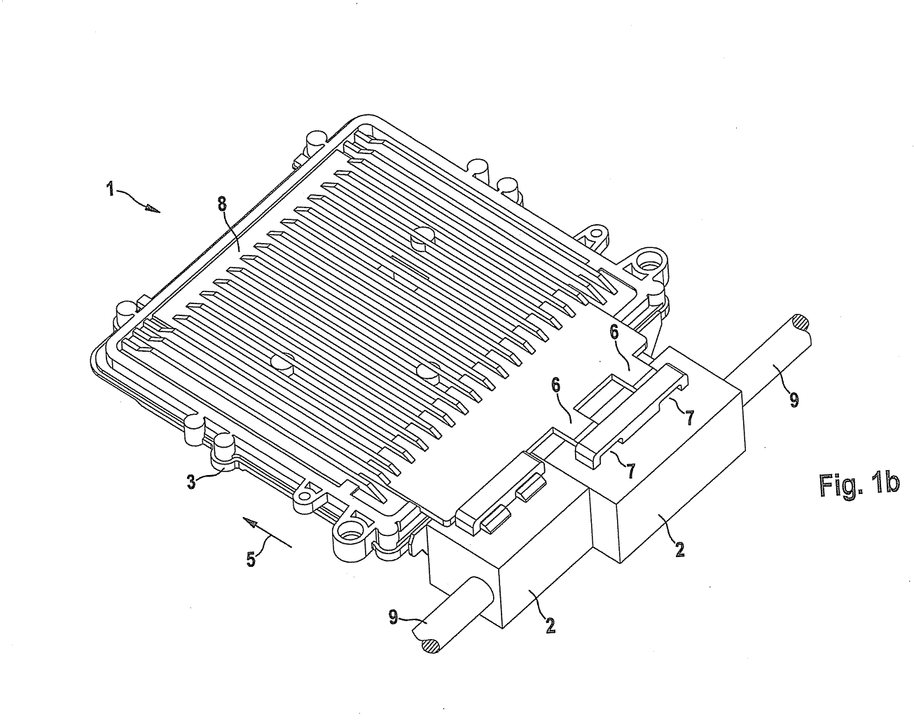

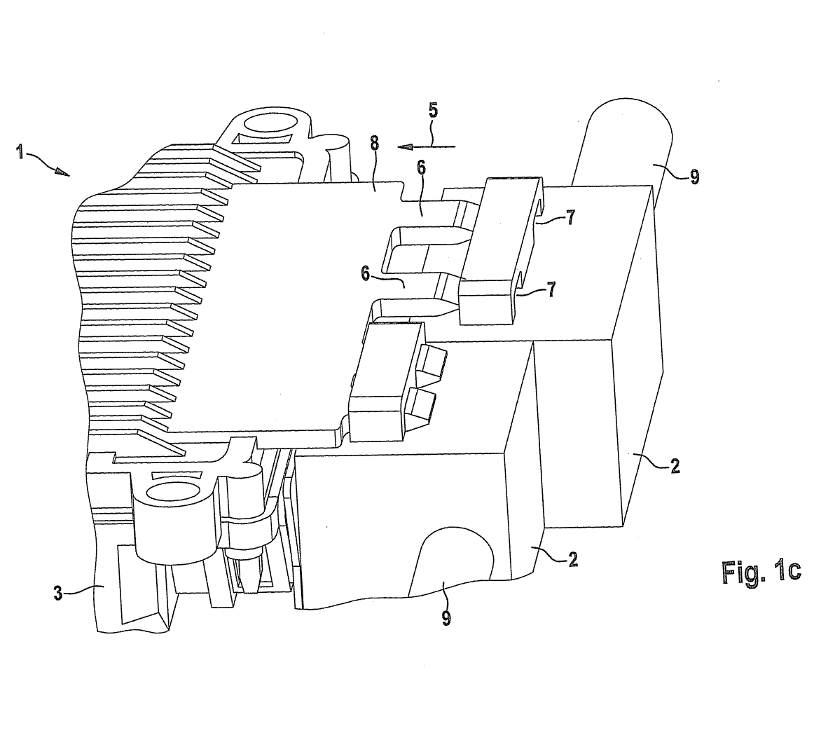

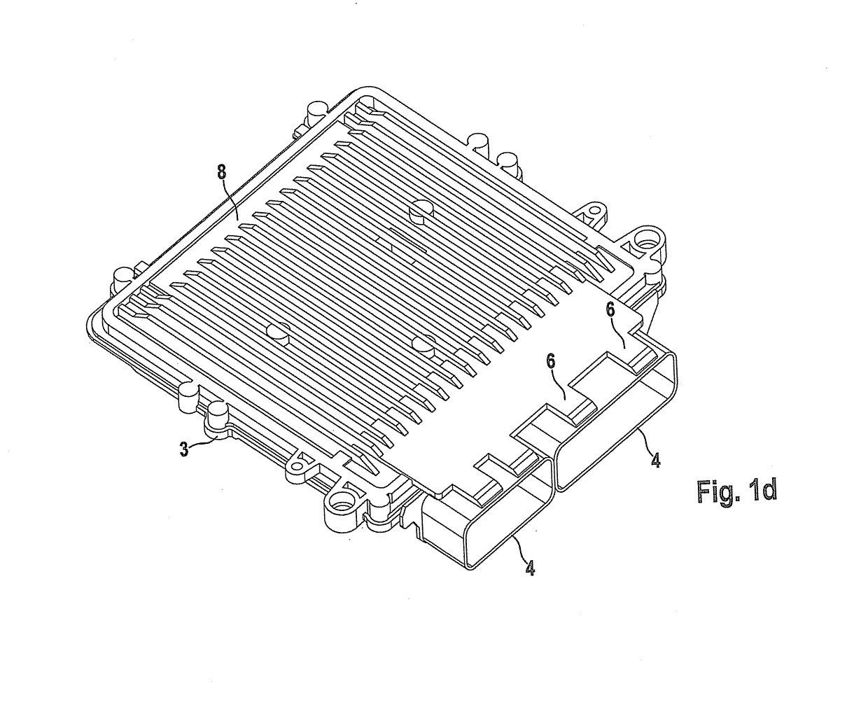

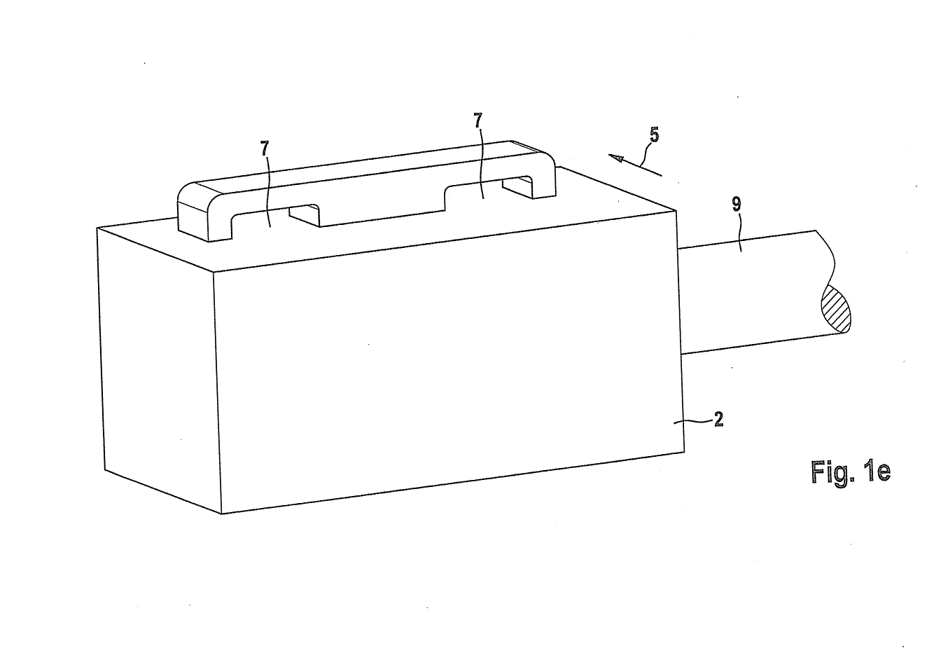

Plug connection 1 shown in FIG. 1 includes two multi-pin cable connectors 2, which may be designed, for example, as cable harness connectors, and a terminal housing 3, which is designed, for example, as a control unit housing and has two troughs or sockets 4 for inserting cable connectors 2 to thus form an electrical plug connection between cable connectors 2 and sockets 3. Each of cable connectors 2 has a male multipoint connector (not shown) and terminal housing 3 has corresponding electrical mating contacts (not shown) within socket 4.

In addition to this electrical plug connection, plug connection 1 also has a non-electrical plug connection between cable connectors 2 and terminal housing 3. This additional non-electrical plug connection is made of two connection pins 6 of terminal housing 3 protruding opposite to connection direction 5 of cable connector 2 and by two corresponding connection receptacles 7 of every cable connector 2. Instead of the two displayed connection pins 6 and two connection receptacles 7, only one connection pin and one connection receptacle or more than two connection pins and two connection receptacles may be provided at cable connector 2 and terminal housing 3. Alternatively, the connection pins may be provided at cable connector 2 and connection receptacles at terminal housing 3.

Connection receptacles 7 are a permanent part of the connector housing of cable connector 2 and may be made of, for example, the frame opening of a molded plastic frame in the case of a connector housing made of plastic. Both connection receptacles 7 are provided on the same housing side of the connector housing.

Connection pins 6 are a permanent part of an adapter 8 or an adapter plate, screwed onto terminal housing 3, and may be cast on, for example if adapter 8 is a die-cast aluminum part, or may be made by reshaping if adapter 8 is a sheet-metal part.

As shown in FIGS. 1a through 1c, every cable connector 2 is pushed with its two connection receptacles 7 onto connection pins 6 of terminal housing 3 during insertion into socket 4 of terminal housing 3 and is thus coupled. As a result of this mechanical coupling, the mass of entire plug connection 1 may be supported via adapter 8 on terminal housing 3, resulting in a reduction of the tilting movements of plug connection 1 in all three spatial axes. The cables of cable connectors 2, e.g. a cable harness, are designated by reference numeral 9.

Tampering protection may be achieved by hidden retaining hooks (not shown) so that plug connection 1 is not able to be disconnected without being destroyed. If connection pins 6—different than shown in FIG. 1d—protrude toward the front beyond socket 4 of the male multipoint connector, the risk of internal damage of the male multipoint connector or its seal in the case of unintentional falling of terminal housing 3 may be prevented and internal damage may deduced from visible damage to connection pins 6.

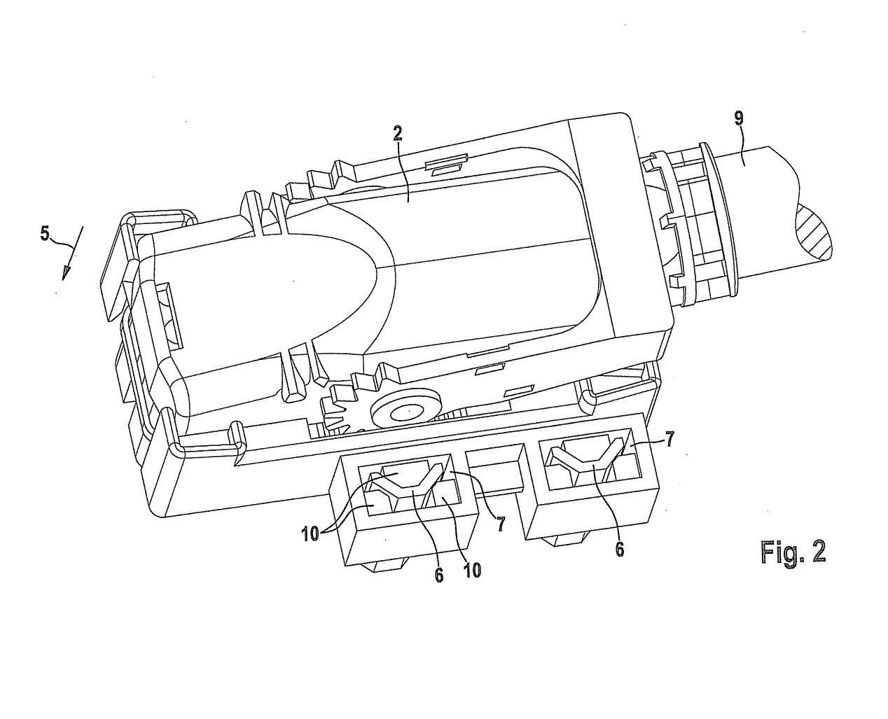

FIG. 2 shows a modified cable connector 2 from above, viewed in its connection direction 5, the terminal housing being omitted with the exception of connection pins 6. Cable connector 2 is pushed with its two connection receptacles 7 at a right angle to the plane of projection onto the two connection pins 6. Connection receptacles 7 are lined with a single-part or multi-part damping element 10 of elastic material to thus further dampen the additional non-electrical plug connection.

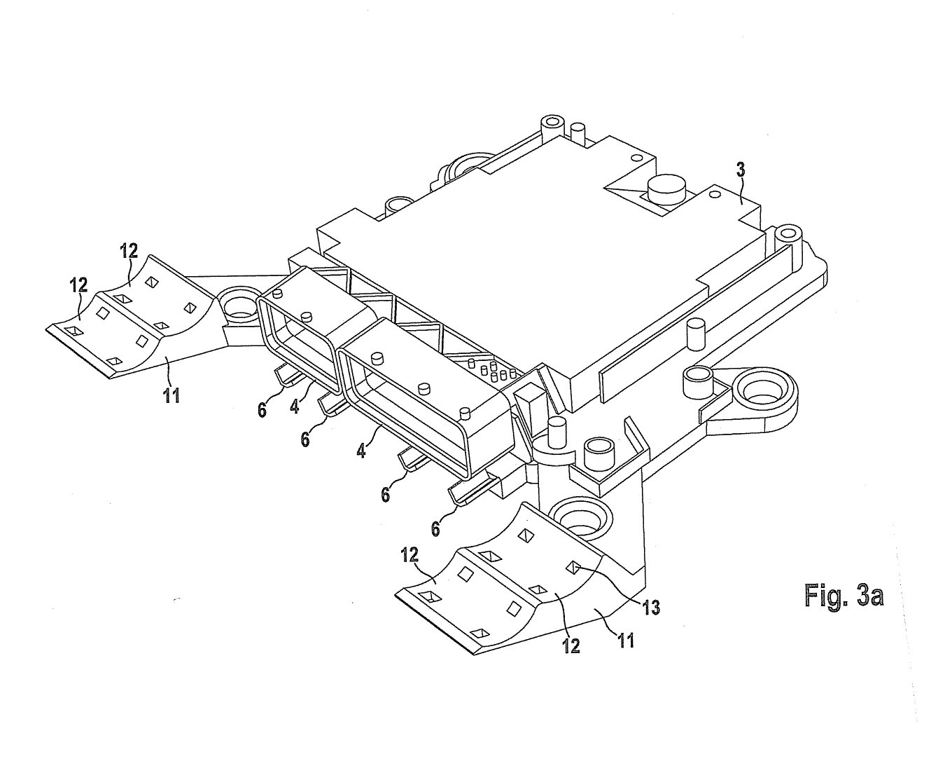

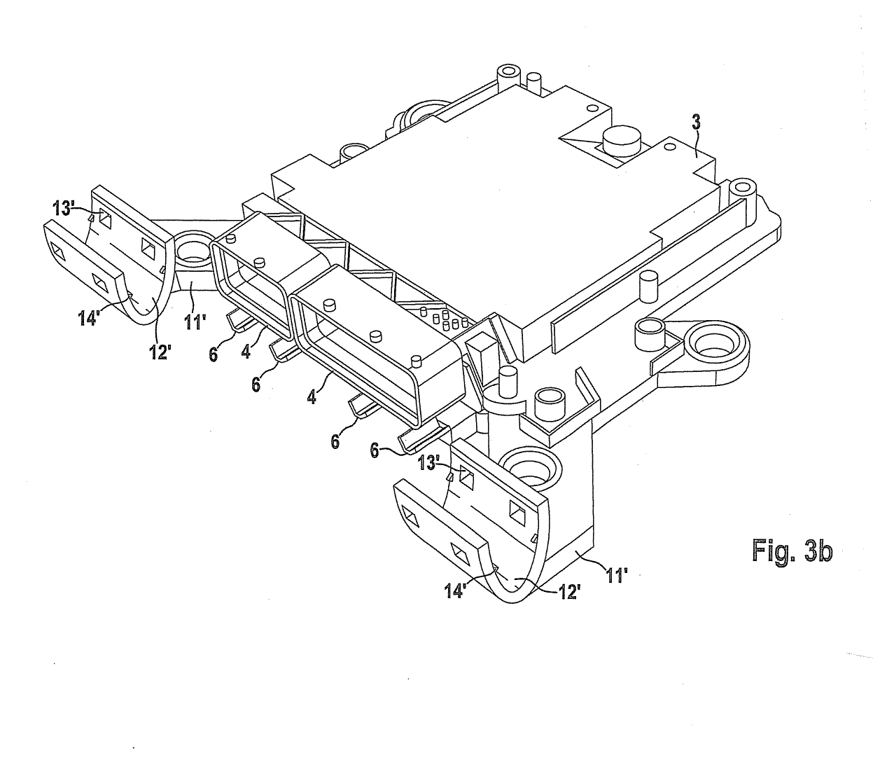

Modified terminal housing 3 shown in FIG. 3a has a housing protrusion 11 on each side of the two sockets 4 having a trough-shaped contact surface 12 for supporting or securing cable 9 of an inserted cable connector 2. In the shown exemplary embodiment, two trough-shaped contact surfaces 12 for different cable connectors 2 are provided on each housing protrusion 11. Four openings 13 for two cable ties are provided in every contact surface 12 as cable securing means to secure supported cable 9 to contact surface 12 at two locations at a distance from one another in the cable longitudinal direction and thus to prevent rotation or torsion of supported cable 9. As a result of this cable securing means integrated directly in terminal housing 3, a phase-equivalent vibration level with respect to terminal housing 3 is ensured and a rotation movement of cable 9 under vibration stress is dampened. Contact surfaces 12 may also be provided on protrusions of adapter 8 instead of on terminal housing 3.

Instead of housing protrusions having two trough-shaped contact surfaces, modified terminal housing 3 shown in FIG. 3b has two housing protrusions 11′ having only a V-shaped or a U-shaped contact surface 12′, which forms a clamping holder in which cable 9 is held by clamping. Four openings 13′ in contact surface 12′ are also used in this case to secure supported cable 9 via cable ties at two locations at a distance from one another in the cable longitudinal direction in order to prevent rotation or torsion of supported cable 9. Alternatively or in addition, V-shaped contact surface 12′ may have one or more protruding notches 14′ or undercuts to retain supported cable 9 in V-shaped contact surface 12′.

1-9. (canceled)

10. A plug connection between at least one cable connector and a terminal housing, comprising:
an electrical plug connection including at least one socket on the terminal housing for inserting the cable connector; and
a non-electrical plug connection between the at least one cable connector and the terminal housing.

11. The plug connection as recited in claim 10, wherein the non-electrical plug connection includes: (i) at least one connection pin of the terminal housing projecting opposite to the connection direction of the cable connector; and (ii) at least one corresponding connection receptacle of the cable connector.

12. The plug connection as recited in claim 11, wherein:
the cable connector has at least two connection receptacles on the same connector housing side; and
the terminal housing has two corresponding connection pins for the two connection receptacles.

13. The plug connection as recited in claim 11, wherein an adapter having one of the connection pin or the connection receptacle for the non-electrical plug connection is secured to the terminal housing.

14. The plug connection as recited in claim 11, wherein at least one damping element of elastic material is situated in the at least one connection receptacle of the non-electrical plug connection.

15. The plug connection as recited in claim 11, wherein the terminal housing has at least one contact surface for securing a cable of the inserted cable connector.

16. The plug connection as recited in claim 15, wherein the at least one contact surface is one of trough-shaped, V-shaped or U-shaped.

17. The plug connection as recited in claim 15, wherein the contact surface has one of a retaining protrusion or a retaining undercut for retaining the cable of the inserted cable connector.

18. The plug connection as recited in claim 15, wherein the at least one contact surface has at least two cable securing openings for cable ties, wherein the at least two cable securing openings are positioned at a distance from one another in the longitudinal direction of the cable of the inserted cable connector.
